(19) United States
(12) Patent Application Publication
(10) Pub. No.: US 2016/0350505 A1
(43) Pub. Date: Dec. 1, 2016

(54) PERSONALIZED LIFESTYLE MODELING DEVICE AND METHOD

(71) Applicant: AJOU UNIVERSITY INDUSTRY-ACADEMIC COOPERATION FOUNDATION, Suwon-si, Gyeonggi-do (KR)

(72) Inventor: We Duke CHO, Seongnam-si (KR)

(73) Assignee: AJOU UNIVERSITY INDUSTRY-ACADEMIC COOPERATION FOUNDATION, Suwon-si, Gyeonggi-do (KR)

(21) Appl. No.: 14/392,252

(22) PCT Filed: Jun. 25, 2014
(86) PCT No.: PCT/KR2014/005622

§ 371 Date: Dec. 24, 2015

(30) Foreign Application Priority Data
Jun. 26, 2013 (KR) 10-2013-0073603

(51) Int. Cl. G06F 19/00

(52) U.S. Cl. CPC G06F 19/3437; G06F 19/3475

(57) ABSTRACT

The present invention relates to an apparatus and a method of modeling a personalized lifestyle which include collecting a lifelog, extracting an individual behavior sequence in the collected lifelog, analyzing an individual tendency by using the collected lifelog, and generating a personalized lifestyle model by retrieving reference models with similar tendencies and considering the reference model and the personal tendency.

### TECHNICAL FIELD

The present invention relates to a technique of managing a lifestyle and more particularly, to a technique of generating a personalized lifestyle model by collecting big data of a personal lifestyle, extracting behavior sequences according to a personalized lifestyle by performing a semantic analysis using the big data, and modeling the extracted behavior sequences to infer a behavior to occur according to a user's state.

### BACKGROUND ART

In Korea, particularly, patients with lifestyle-related diseases are rapidly increased, and patients with similar metabolic diseases which are not simply explained only westernization of dietary life, aging, and an increase in obese people appears from infancy and adolescence. The lifestyle-related diseases are not resolved well by medical drug treatment and medical costs of national health insurance have steadily increased with development of chronic diseases. As the solution thereof, lifestyle medicine has been important, but is difficult to be applied due to problems such as difficulty of a traditional medial examination method, continuous treatment effect, systematic management of the patients, and substantial effects.

Currently, various IT products and care services (child protection and growth care, elderly protection care, spiritual healing care of the public, financial forecasting management in a rapidly changing economic situation, and the like) have fundamental limits in application and advancement because understanding, expression, and quantifying for “human” as the final user and a complicated characteristic thereof (social relationship, psychology, physiology, emotion, and the like) are not easy.

Particularly, consideration for elements that determine “I” represented by the lifestyle is insufficient, and there is difficulty in tools or methods to characteristically express the human beings with complicated and various characteristics.

As a method for overcoming the problems, various researches of using lifelog data have been conducted globally, but absence of innovative devices for collecting the lifelog and dilemma of semantic analysis of a vast amount of data are still not resolved.

As an example of a life care service technique in the related art, “a system of providing a life care service” in Korea Patent Publication No. 2012-0045459 was proposed. In the prior art, a life care service technique of collecting information as a life required to verify a health state of the user and analyzing lifelog information to provide life care information used for managing the lifestyle of the user was disclosed.

However, in the related art, in order to manage the lifestyle of the user by analyzing the lifelog information, first, a process of setting the lifestyle is required and rules corresponding to a specific situation need to be predetermined. In the prior art, the predetermined rules have individual differences, but are not considered and not properly changed depending on the time flow, and a detailed technique for a method of setting the rules is not mentioned. Further, in the prior art, when the lifelog is analyzed, human diversity is not considered.

Therefore, a method of managing a user's health by collecting big data of a personal lifelog, performing a semantic analysis using the big data to extract a general behavior sequence and a behavior sequence according to a personalized lifestyle, and modeling the extracted behavior sequence to infer a behavior to occur according to a user's state and induce the inferred behavior in a desirable direction is required.

### DISCLOSURE

### Technical Problem

The present invention is directed to provide an apparatus and a method for modeling a personalized lifestyle.

In detail, the present invention is directed to provide an apparatus and a method for modeling a personalized lifestyle which include collecting a lifelog, extracting an individual behavior sequence from the collected lifelog, analyzing an individual tendency by using the collected lifelog, and generating a personalized lifestyle model for each tendency by connecting behavior sequences of users with similar tendencies.

### Technical Solution

One aspect of the present invention provides an apparatus for modeling a personalized lifestyle including: a log collecting unit configured to collect a lifelog of a personal user; a sequence extracting unit configured to extract a sequence of a behavior which frequently occurs by using the collected lifelog with respect to the personal user; a tendency analyzing unit configured to calculate a probability that the extracted sequence is associated with at least one of reference models classified for each type with respect to multiple users and extract at least one optimal reference model matched with the extracted sequence; and a personalized model generating unit configured to generate a personalized lifestyle model which adds the extracted sequence to the optimal reference model by considering the difference between the reference model and the extracted sequence.

In this case, the lifelog may include at least one of private data, public data, personal data, anonymous data, connected data, and sensor data.

Further, the tendency analyzing unit may express a behavior pattern in a graph form by matching at least one of the reference models with the extracted sequence.

Further, in the graph, a behavior weight may be granted to correct a difference between a behavior indicated by at least one of the reference models and an actual behavior of the personal user in addition to at least one of the reference models and at least one of a frequency of the actual behavior of the personal user and a probability to be executed.

Further, the tendency analyzing unit may analyze the individual tendency by using activity information in an individual social network included in the collected lifelog and extract an optimal reference model by filtering the reference model similar to the user in advance.

Further, the personalized model generating unit may further include a lifestyle unique pattern extracting unit for generating a personalized lifestyle model by adding the difference between the reference model and the extracted sequence.

Further, the personalized model generating unit may generate a personalized lifestyle model united by collecting feedback information of the user to reflect the collected feedback information to the behavior weight of the lifestyle unique pattern.

Another aspect of the present invention provides a method for modeling a personalized lifestyle including: collecting a lifelog of a personal user; extracting a sequence of a behavior which frequently occurs by using the collected lifelog with respect to the personal user; calculating a probability that the extracted sequence is associated with at least one of reference models classified for each type with respect to multiple users and extracting at least one optimal reference model matched with the extracted sequence; and generating a personalized lifestyle model which adds the extracted sequence to the optimal reference model by considering the difference between the reference model and the extracted sequence.

In this case, the lifelog may include at least one of private data, public data, personal data, anonymous data, connected data, and sensor data.

Further, in the analyzing of the tendency, a behavior pattern may be expressed in a graph form by matching at least one of the reference models with the extracted sequence.

Further, in the graph, a behavior weight may be granted to correct a difference between a behavior indicated by at least one of the reference models and an actual behavior of the personal user in addition to at least one of the reference models and at least one of a frequency of the actual behavior of the personal user and a probability to be executed.

Further, in the analyzing of the tendency, the individual tendency may be analyzed by using activity information in an individual social network included in the collected lifelog and an optimal reference model is extracted by filtering the reference model similar to the user in advance.

Further, the generating of the personalized model may further include a lifestyle unique pattern extracting unit for generating a personalized lifestyle model by adding the difference between the reference model and the extracted sequence.

Further, in the generating of the personalized model, a personalized lifestyle model united by collecting feedback information of the user to reflect the collected feedback information to the behavior weight of the lifestyle unique pattern may be generated.

### Advantageous Effects

According to the present invention, by collecting a lifelog, extracting an individual behavior sequence from the collected lifelog, analyzing an individual tendency by using the collected lifelog, and generating a personalized lifestyle model for each tendency by connecting behavior sequences of users with similar tendencies, a user or an expert may generate the reference model by using the collected lifelog without directly setting the behavior sequence, and the reference model may be properly changed according to data accumulated with time to be evolved over time.

### DESCRIPTION OF DRAWINGS

FIG. 1 is a diagram illustrating a configuration of an autonomous lifestyle care system according to an exemplary embodiment of the present invention.

FIG. 2 is a diagram illustrating a configuration of a reference modeling device for modeling a generalized lifestyle according to the exemplary embodiment of the present invention.

FIG. 3 is a diagram illustrating a configuration of a personalized modeling device for modeling a personalized lifestyle according to the exemplary embodiment of the present invention.

FIG. 4 is a flowchart illustrating a process of managing the lifestyle in the autonomous lifestyle care system according to the exemplary embodiment of the present invention.

FIG. 5 is a flowchart illustrating a process of generating a reference model in the reference modeling device according to the exemplary embodiment of the present invention.

FIG. 6 is a flowchart illustrating a process of generating a personalized lifestyle model in the personalized modeling device according to the exemplary embodiment of the present invention.

FIG. 7 is a diagram illustrating an example of the reference model generated according to the exemplary embodiment of the present invention.

FIG. 8 is a diagram illustrating a configuration of an apparatus for modeling a personalized lifestyle according to another exemplary embodiment of the present invention.

FIG. 9 is a diagram illustrating an example of matching the reference models according to the exemplary embodiment of the present invention.

FIG. 10 is a diagram illustrating an example of generating a graph matching the reference models according to the exemplary embodiment of the present invention.

FIG. 11 is a flowchart illustrating a method for modeling a personalized lifestyle according to yet another exemplary embodiment of the present invention.

### BEST MODE OF THE INVENTION

One aspect of the present invention provides an apparatus for modeling a personalized lifestyle including: a log collecting unit configured to collect a lifelog of a personal user; a sequence extracting unit configured to extract a sequence of a behavior which frequently occurs by using the collected lifelog with respect to the personal user; a tendency analyzing unit configured to calculate a probability that the extracted sequence is associated with at least one of reference models classified for each type with respect to multiple users and extract at least one optimal reference model matched with the extracted sequence; and a personalized model generating unit configured to generate a personalized lifestyle model which adds the extracted sequence to the optimal reference model by considering the difference between the reference model and the extracted sequence.

In this case, the lifelog may include at least one of private data, public data, personal data, anonymous data, connected data, and sensor data.

Further, the tendency analyzing unit may express a behavior pattern in a graph form by matching at least one of the reference models with the extracted sequence.

Further, in the graph, a behavior weight may be granted to correct a difference between a behavior indicated by at least one of the reference models and an actual behavior of the personal user in addition to at least one of the reference models and at least one of a frequency of the actual behavior of the personal user and a probability to be executed.

Further, the tendency analyzing unit may analyze the individual tendency by using activity information in an individual social network included in the collected lifelog and extract an optimal reference model by filtering the reference model similar to the user in advance.

Further, the personalized model generating unit may further include a lifestyle unique pattern extracting unit for generating a personalized lifestyle model by adding the difference between the reference model and the extracted sequence.

Further, the personalized model generating unit may generate a personalized lifestyle model united by collecting feedback information of the user to reflect the collected feedback information to the behavior weight of the lifestyle unique pattern.

Another aspect of the present invention provides a method for modeling a personalized lifestyle including: collecting a lifelog of a personal user; extracting a sequence of a behavior which frequently occurs by using the collected lifelog with respect to the personal user; calculating a probability that the extracted sequence is associated with at least one of reference models classified for each type with respect to multiple users and extracting at least one optimal reference model matched with the extracted sequence; and generating a personalized lifestyle model which adds the extracted sequence to the optimal reference model by considering the difference between the reference model and the extracted sequence.

In this case, the lifelog may include at least one of private data, public data, personal data, anonymous data, connected data, and sensor data.

Further, in the analyzing of the tendency, a behavior pattern may be expressed in a graph form by matching at least one of the reference models with the extracted sequence.

Further, in the graph, a behavior weight may be granted to correct a difference between a behavior indicated by at least one of the reference models and an actual behavior of the personal user in addition to at least one of the reference models and at least one of a frequency of the actual behavior of the personal user and a probability to be executed.

Further, in the analyzing of the tendency, the individual tendency may be analyzed by using activity information in an individual social network included in the collected lifelog and an optimal reference model is extracted by filtering the reference model similar to the user in advance.

Further, the generating of the personalized model may further include a lifestyle unique pattern extracting unit for generating a personalized lifestyle model by adding the difference between the reference model and the extracted sequence.

Further, in the generating of the personalized model, a personalized lifestyle model united by collecting feedback information of the user to reflect the collected feedback information to the behavior weight of the lifestyle unique pattern may be generated.

### Modes of the Invention

Other objects and features than the above-described object will be apparent from the description of exemplary embodiments with reference to the accompanying drawings.

Hereinafter, exemplary embodiments of the present invention will be described in detail with reference to the accompanying drawings. Further, in the following description, a detailed explanation of known related technologies may be omitted to avoid unnecessarily obscuring the subject matter of the present invention.

However, the present invention is not restricted or limited to the exemplary embodiments. Like reference numerals illustrated in the respective drawings designate like members.

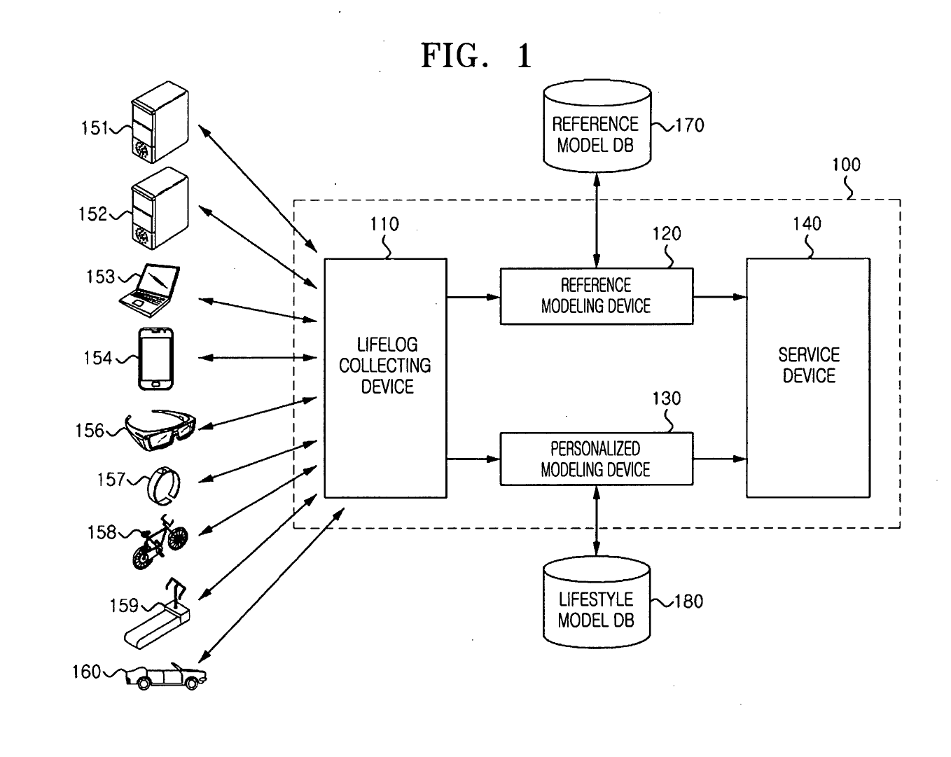

Hereinafter, autonomous lifestyle care system and method according to an exemplary embodiment of the present invention will be described in detail with reference to FIGS. 1 to 7.

FIG. 1 is a diagram illustrating a configuration of an autonomous lifestyle care system according to an exemplary embodiment of the present invention.

Referring to FIG. 1, an autonomous lifestyle care system 100 may include a lifelog collecting device 110, a reference modeling device 120, a personalized modeling device 130, and a service device 140.

The lifelog collecting device 110 may collect the lifelog by communicating with a private data management server 151, a public data management server 152, a personal computer 153, a smart phone 154, smart glasses 155, a smart watch 157, a bicycle 158, a running machine 159, a vehicle 160, and the like.

In this case, the lifelog may include at least one of private data, public data, personal data, anonymous data, connected data, and sensor data.

Here, the private data may include a calendar, an address book, credit card details, medical records, shopping details, call records, text records, bank records, stock trading records, various financial transaction records, and the like.

The public data may include traffic information, weather information, various statistical data, and the like.

The personal data may include favorites, search records, social networking service (SNS) conversation records, download records, blog records, and the like.

The anonymous data may include topic information (trend of public opinion) issued in the SNS, news, real-time keyword ranking, and the like.

The connected data may include records connected with a home or a vehicle and the like and for example, include occupancy detection, RFID (individual identification and access records), digital door locks, smart applications (use information), home network use records, Internet use records (access point), a car navigation system (movement path, etc.), a black box (video and audio records), tachographs (driving time, driving patterns, etc.).

The sensor data may include data measured through a dedicated device, an environmental sensor, a smart device, medical equipment, personal exercise equipment, a personal activity measuring device, and the like.

Here, the dedicated device may include a calorie measuring device, a position measuring device, a thermometer, a stress measuring device, an oral bad breath measuring device, a breathalyzer, distance/speed, GPS-based position measuring device, an apnea measuring device, a snoring measuring device, and the like.

The environment sensor may include a temperature sensor, a humidity sensor, a luminance sensor, CCTVs (streets, public transports, buildings, etc.), a carbon dioxide measuring sensor, an ozone measuring sensor, a carbon monoxide measuring sensor, a dust measuring sensor, a UV measuring sensor, and the like.

The smart device includes a smart phone, a head-mounted display (Google Glass, etc.), and a smart watch (Apple iWatch, etc.), and may acquire data such application payment details, often used applications, application usage details, GPS (location), recorded videos, audios, photos, and favorite music, and the like.

The medical equipment may include an electronic balance, a body fat measuring device, a diabetes measuring device, a heart rate measuring device, a blood pressure measuring device, and the like, and the measured data may include sensor data.

The personal exercise equipment may include exercise equipment capable of measuring an exercising amount such as sensors attached with a running machine, a bicycle, and running shoes, and the exercising amount measured from the exercise equipment may include sensor data.

Meanwhile, the lifelog collecting device 110 may be constituted by a separate device, but may be included in the reference modeling device 120 or the personalized modeling device 130.

The reference modeling device 120 receives the lifelog collected from the lifelog collecting device 110 and generates a reference model by using the collected lifelog.

In this case, the reference modeling device 120 may extract behavior sequences in the collected lifelog, analyze similarity between the extracted behavior sequences, and align the behavior sequences by using a sequence alignment method to generate the reference model. A more detailed description of the reference modeling device 120 will be described below with reference to FIG. 2.

The personalized modeling device 130 receives the lifelog collected from the lifelog collecting device 110, analyzes an individual tendency by using the collected lifelog, and generates a personalized lifestyle model for each tendency.

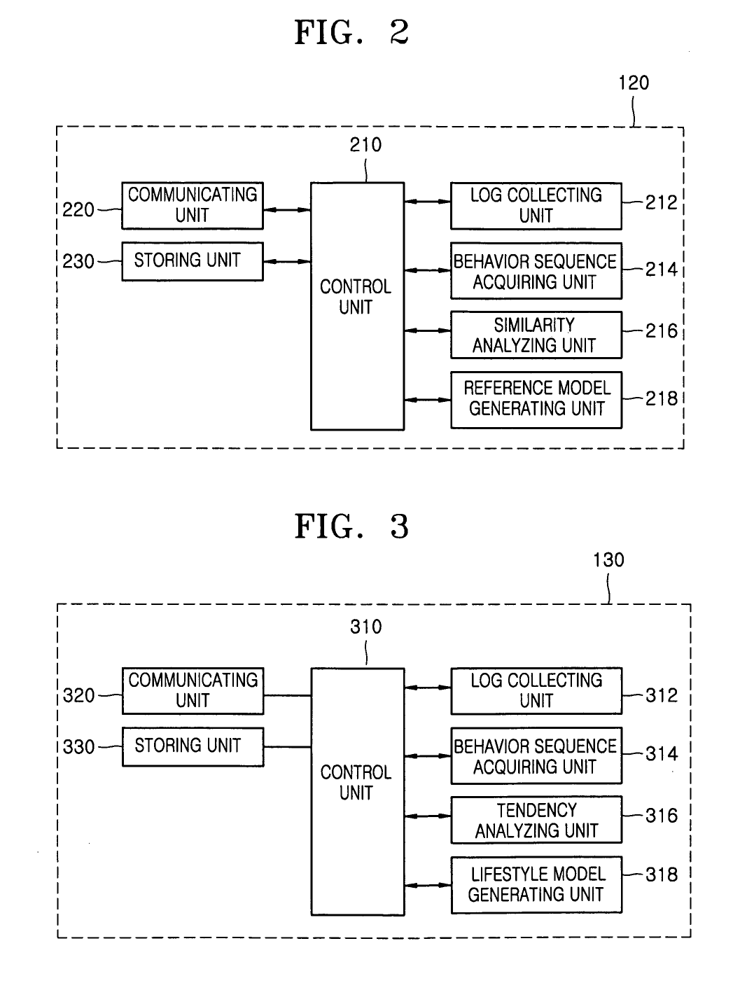

The personalized modeling device 130 may extract a behavior pattern which is repeated more than a predetermined number of times for each individual by using a data mining method in the collected lifelog as the individual behavior sequence, analyzes the individual tendency by analyzing activity information in an individual social network included in the collected lifelog, and generate the personalized lifestyle model for each tendency by connecting behavior sequences of users having similar tendencies. A more detailed description of the personalized modeling device 130 will be described below with reference to FIG. 3.

The reference model generated in the reference modeling device 120 in the reference modeling device 120 and the personalized lifestyle model generated in the personalized modeling device 130 tend to be more accurate as the lifelogs are more and more accumulated. Accordingly, the reference model and the personalized lifestyle model automatically reflect the behavior sequences that may vary according to the age as time passes to be evolved over time.

Meanwhile, the reference model generated in the reference modeling device 120 in the reference modeling device 120 and the personalized lifestyle model generated in the personalized modeling device 130 may be united for the service to be provided to the service device 140.

The service device 140 estimates a possible user's behavior based on current information of the user which is collected by using the reference model received from the reference modeling device 120 and the personalized lifestyle model received from the personalized modeling device 130 and verifies whether the estimated user's behavior has a bad effect on the user's health.

As the verified result, when the estimated user's behavior has the bad effect on the user's health, the service device 140 may induce the user to avoid the estimated user's behavior. In this case, the service device 140 may use a direct method and an indirect method as the method of avoiding the estimated user's behavior.

The direct method is a method in which the user directly recognizes and avoids the possible behavior by transmitting the possible user's behavior to the user.

The indirect method as an unobtrusive method is a method of avoiding the user's behavior from occurring in advance by indicating any behavior to the user. Accordingly, in the indirect method, the user may not recognize the possible behavior.

For example, when verifying the personalized lifestyle model of any user, in the case of having a behavior sequence in which the user overeats meat in a meat restaurant on the way home when the user feels bad, if the user's current state is in a bad state, the user is on the way home from work, and the weight of the current user is obese, the user may be induced to avoid the behavior of overeating the meat by recommending a different path without the meat restaurant.

Further, in the case of additionally having a behavior sequence in which the user feels good when the user walks on the flower way, the user may be induced to change the user's feeling by providing the work-off path via the flower way.

FIG. 2 is a diagram illustrating a configuration of a reference modeling device modeling a generalized lifestyle according to the exemplary embodiment of the present invention.

Referring to FIG. 2, the reference modeling device 120 may include a control unit 210, a log collecting unit 212, a behavior sequence acquiring unit 214, a similarity analyzing unit 216, a reference model generating unit 218, a communicating unit 220, and a storing unit 230.

The communicating unit 220 transmits and receives data in wired manner or wirelessly as a communication interface device including a receiver and a transmitter. The communicating unit 220 may communicate with the lifelog collecting device 110, the service device 140, and the reference model DB 170 and directly communicates with a device of providing the lifelog to receive the lifelog.

The storing unit 230 may store an operating system for controlling the overall operation of the reference modeling device 120, application programs, and the like and further store the collected lifelog and the generated reference model according to the present invention. In this case, the storing unit 230 may be a storage device including a flash memory, a hard disk drive, and the like.

The log collecting unit 212 may receive the lifelog or receive the lifelog collected in the lifelog collecting device 110 through the communicating unit 220.

The behavior sequence acquiring unit 214 extracts the behavior sequences in the collected lifelog.

In more detail, the behavior sequence acquiring unit 214 extracts the behavior sequence having at least one of a stimulation idea, a recognition, an emotion, a behaviors, and a result in the collected lifelog by using a data mining method. In this case, the behavior sequence having the stimulation idea, the recognition, the emotion, the behaviors, and the result may be expressed like examples of Table 1.

TABLE 1

| Stimulation | | | | |
|---|---|---|---|---|
| Idea | Recognition | Emotion | Behaviors | Result |
| Thtreat | Danger | Fear, terror | Running, or | Protection |
| | | | flying away | |
| Obstacle | Enemy | Anger, rage | Biting, hitting | Destruction |
| Potential Mate | Possess | Joy, ecstasy | Courting, | Reproduction |
| | | | mating | |
| Loss of valued | Isolation | Sadness, greif | Crying for help | Reintegration |
| person | | | | |
| Gruesome | Poison | Disgust, | Vomiting, | Rejection |
| object | | loathing | pushing away | |
| Group member | Friend | Acceptance, | Grooming, | Affiliation |
| | | trust | sharing | |
| New territory | What's out | Anticipation | Examining, | Exploration |
| | there? | | mapping | |
| Sudden novel | What is it? | Surprise | Stopping, | Orientation |
| object | | | alerting | |

The behavior sequence acquiring unit 214 may extract the behavior sequence in the collected lifelog, but may also receive the behavior sequence from a user or an expert (a psychologist, etc.).

The similarity analyzing unit 216 analyzes similarity between the behavior sequences acquired through the behavior sequence acquiring unit 214.

In more detail, the similarity analyzing unit 216 may evaluate the similarity between the extracted behavior sequences by using at least one of whether the behavior sequence occurs within a predetermined time and whether information included in the behavior sequence is the same.

The reference model generating unit 218 aligns the behavior sequences by using a sequence alignment method to generate the reference model.

In more detail, the reference model generating unit 218 connects behavior sequences having high similarity in a tree form by using the similarity of the extracted behavior sequences to generate an ontology type reference model.

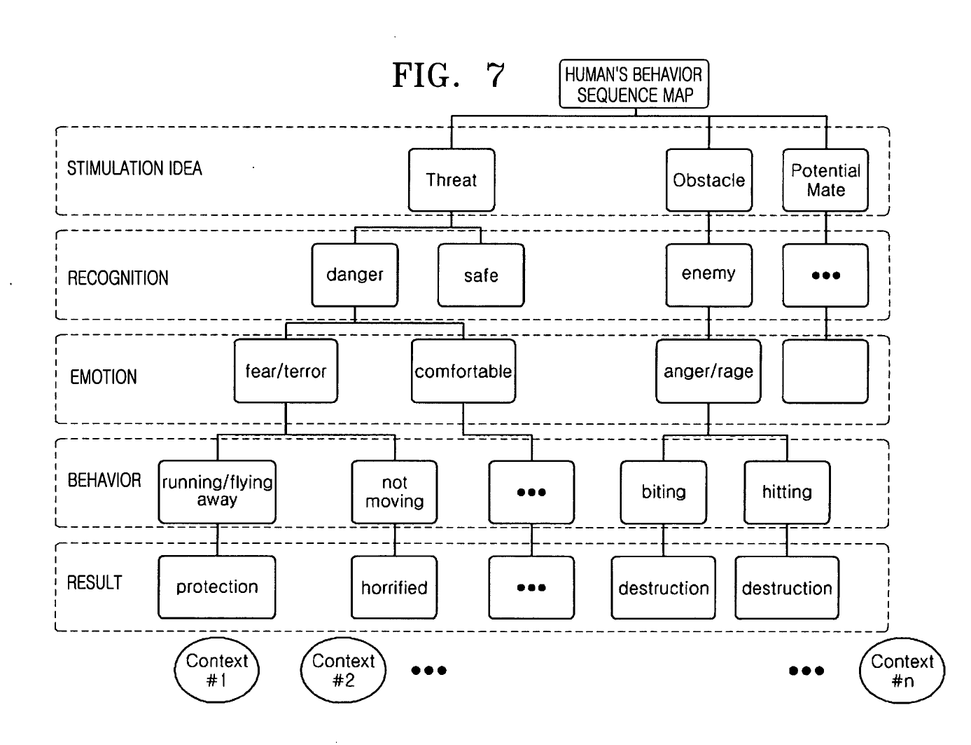

FIG. 7 is a diagram illustrating an example of the reference model generated according to the exemplary embodiment of the present invention.

FIG. 7 is an example of generating the behavior sequence in Table 1 as the reference model, and referring to FIG. 7, it can be seen that the reference model is constituted by a tree type ontology model.

A sequence alignment technique applied to the reference model generating unit 218 is a method which is frequently used in the similarity analysis of base sequences in a bioinformatics field and may be modified and applied to the prevent invention like the following Table 2.

TABLE 2

| | | Sequence Alignment |
|---|---|---|
| | | (Examples applied to |
| | Sequence Alignment | present invention) |
| Description | Method of analyzing similarity | Method of analyzing |
| | between base sequences | similarity between |
| | | behavior sequences |
| Comparison | Reference sequence | Bottom up build by using |
| | | algorithm in which path |
| | | extraction is possible like |
| | | decision tree |
| | read | Behavior occurring in |
| | | predetermined time |
| | | window |
| | Similar species/neighboring | Classification through |
| | species | Human profiling |
| | mismatch | Diversity of behavior |
| | | patterns according to |
| | | human/time/place |

The control unit 210 may control the overall operation of the reference modeling device 120. In addition, the control unit 210 may perform functions of the log collecting unit 212, the behavior sequence acquiring unit 214, the similarity analyzing unit 216, and the reference model generating unit 218. The control unit 210, the log collecting unit 212, the behavior sequence acquiring unit 214, the similarity analyzing unit 216, and the reference model generating unit 218 are separately illustrated to describe the respective functions. Accordingly, the control unit 210 may include at least one processor configured to perform the respective functions of the log collecting unit 212, the behavior sequence acquiring unit 214, the similarity analyzing unit 216, and the reference model generating unit 218. Further, the control unit 210 may include at least one processor configured to perform some of the respective functions of the log collecting unit 212, the behavior sequence acquiring unit 214, the similarity analyzing unit 216, and the reference model generating unit 218.

FIG. 3 is a diagram illustrating a configuration of a personalized modeling device modeling a personalized lifestyle according to the exemplary embodiment of the present invention.

Referring to FIG. 3, the personalized modeling device 130 may include a control unit 310, a log collecting unit 312, a behavior sequence acquiring unit 314, a tendency analyzing unit 316, a lifestyle model generating unit 318, a communicating unit 320, and a storing unit 330.

The communicating unit 320 transmits and receives data in wired manner or wirelessly as a communication interface device including a receiver and a transmitter. The communicating unit 320 may communicate with the lifelog collecting device 110, the service device 140, and the reference model DB 180 and may directly communicate with a device of providing the lifelog to receive the lifelog.

The storing unit 330 may store an operating system for controlling the overall operation of the personalized modeling device 130, application programs, and the like and further store the collected lifelog and the generated personalized lifestyle model according to the present invention. In this case, the storing unit 330 may be a storage device including a flash memory, a hard disk drive, and the like.

The log collecting unit 312 may receive the lifelog or receive the lifelog collected in the lifelog collecting device 110 through the communicating unit 320.

The behavior sequence acquiring unit 314 extracts individual behavior sequences in the collected lifelog. In more detail, the behavior sequence acquiring unit 314 retrieves the behavior pattern which is repeated more than a predetermined number of times for each individual in the collected lifelog by using the data mining method to extract the retrieved behavior pattern as the individual behavior sequence.

Meanwhile, the behavior sequence acquiring unit 314 may extract the behavior sequence in the collected lifelog, but may also receive the behavior sequence from a user or an expert (a psychologist, etc.).

The tendency analyzing unit 316 analyzes the individual tendency by using the collected lifelog. In more detail, the tendency analyzing unit 316 analyzes the individual tendency by determining interest, taste, and activity of each individual in activity information in the individual social network included in the collected lifelog. In this case, the activity information in the social network may include the number of access times to the social network, visited objects, the number of registered friends, the number of times of postings, the number of times of responses, analysis of the posting contexts, and the like.

The behavior sequence acquiring unit 314 and the tendency analyzing unit 316 may use Hadoop and MapReduce techniques as distributed computing techniques for analyzing a large lifelog. That is, the behavior sequence acquiring unit 314 and the tendency analyzing unit 316 stores and manages the individual behavior sequence through a Hadoop system and may distributed-process an analysis technique through MapReduce.

The lifestyle model generating unit 318 generates the personalized lifestyle model for each tendency by connecting the behavior sequences of the users having similar tendencies.

In more detail, the lifestyle model generating unit 318 analyzes similarity between the behavior sequences of the users having similar tendencies and may generate an ontology type personalized lifestyle model for each tendency by connecting the behavior sequences with high similarity in a tree form.

Meanwhile, the individual uses a specific heuristic for his determination or behavior, and verification of conformity of the individual lifestyle model is required by using the heuristic.

In the verification of conformity of the individual lifestyle model, an individual heuristic is determined by using the individual heuristic which is already devised by psychologists and physiologists. As a method for determining the individual heuristic, conformity of the individual heuristic and the individual lifestyle model may be verified by using question investigation and the like.

In addition, the individual lifestyle model may be readjusted by determining association between the individual lifestyle model and the heuristic of the user, determining conformity of the individual lifestyle model base on the heuristic (in association with the psychologist and the physiologist), and analyzing the heuristic.

However, a method of minimizing intervention of the user or the expert is preferably a method of verifying the conformity of the individual lifestyle model by estimating the individual heuristic through existing accumulated behavior sequences and the individual lifestyle model and retrieving the behavior sequences of the users having the same or similar heuristic to draw similar patterns between the individual lifestyle models.

The control unit 310 may control the overall operation of the personalized modeling device 130. In addition, the control unit 310 may perform functions of the log collecting unit 312, the behavior sequence acquiring unit 314, the tendency analyzing unit 316, and the lifestyle model generating unit 318. The control unit 310, the log collecting unit 312, the behavior sequence acquiring unit 314, the tendency analyzing unit 316, and the lifestyle model generating unit 318 are separately illustrated to describe the respective functions. Accordingly, the control unit 310 may include at least one processor configured to perform the respective functions of the log collecting unit 312, the behavior sequence acquiring unit 314, the tendency analyzing unit 316, and the lifestyle model generating unit 318. Further, the control unit 310 may include at least one processor configured to perform the respective functions of the log collecting unit 312, the behavior sequence acquiring unit 314, the tendency analyzing unit 316, and the lifestyle model generating unit 318.

Hereinafter, a method of managing the lifestyle in the autonomous lifestyle care system will be described below with reference to the accompanying drawings.

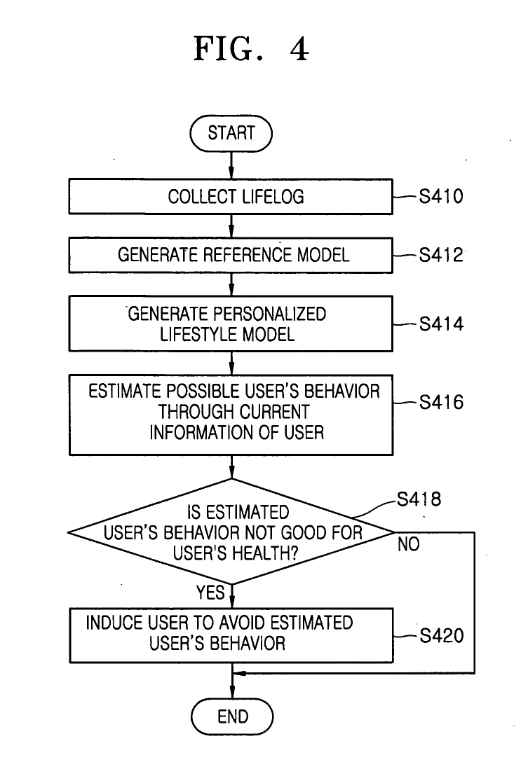

FIG. 4 is a flowchart illustrating a process of managing the lifestyle in the autonomous lifestyle care system according to the exemplary embodiment of the present invention.

Referring to FIG. 4, an autonomous lifestyle care system 100 collects the lifelog including at least one of private data, public data, personal data, anonymous data, connected data, and sensor data (S410).

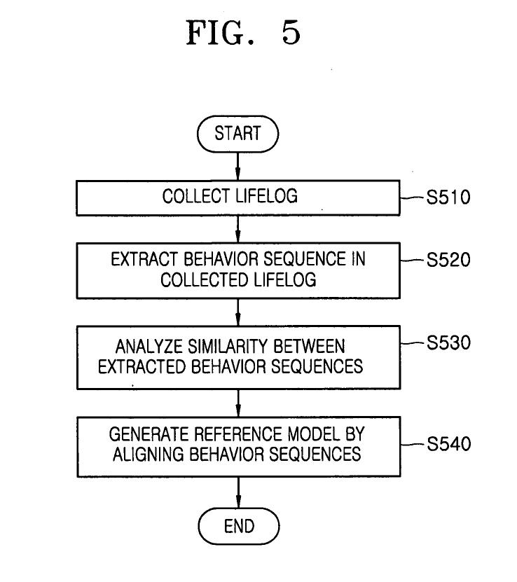

In addition, the autonomous lifestyle care system 100 generates the reference model by using the collected lifelog (S412). In this case, the autonomous lifestyle care system 100 may extract behavior sequences in the collected lifelog, analyze similarity between the extracted behavior sequences, and align the behavior sequences by using a sequence alignment method to generate the reference model. The generating of the reference model will be described below in more detail with reference to FIG. 5.

In addition, the autonomous lifestyle care system 100 analyzes an individual tendency by using the collected lifelog and generates a personalized lifestyle model for each tendency (S414).

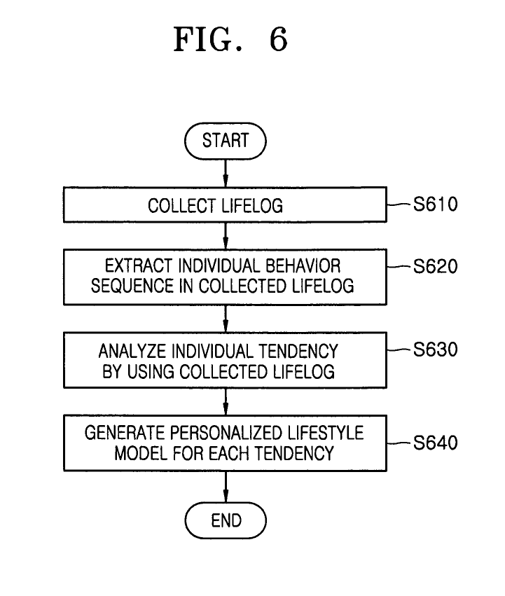

In this case, the autonomous lifestyle care system 100 may extract a behavior pattern which is repeated more than a predetermined number of times for each individual by using a data mining method in the collected lifelog as the individual behavior sequence, analyzes the individual tendency by analyzing activity information in an individual social network included in the collected lifelog, and generate the personalized lifestyle model for each tendency by connecting behavior sequences of users having similar tendencies. The generating of the personalized lifestyle model will be described below in more detail with reference to FIG. 6.

In addition, the autonomous lifestyle care system 100 estimates a possible user's behavior by reflecting user's current information which is collected in the reference model and the lifestyle model (S416).

In addition, the autonomous lifestyle care system 100 verifies whether the estimated user's behavior has a bad effect on the user's health (S418).

As verified in step S418, when the estimated user's behavior has the bad effect on the user's health, the autonomous lifestyle care system 100 induces the user to avoid the estimated user's behavior (S420).

In this case, the autonomous lifestyle care system 100 may transmit the possible user's behavior to the user in order to induce the user to avoid the estimated user's behavior or prevent the user's behavior from occurring by indicating any behavior to the user.

FIG. 5 is a flowchart illustrating a process of generating a reference model in the reference modeling device according to the exemplary embodiment of the present invention.

Referring to FIG. 5, the reference modeling device 120 collects the lifelog including at least one of private data, public data, personal data, anonymous data, connected data, and sensor data (S510).

In addition, the reference modeling device 120 extracts the behavior sequence in the collected lifelog (S520). In this case, the reference modeling device 120 may extract the behavior sequence having at least one of stimulation idea, recognition, emotion, behavior, and result in the collected lifelog by using a data mining method.

In addition, the reference modeling device 120 analyzes similarity between the extracted behavior sequences (S530). In this case, the reference modeling device 120 may evaluate and analyze the similarity between the extracted behavior sequences by using at least one of whether the behavior sequence occurs within a predetermined time and whether information included in the behavior sequence is the same.

In addition, the reference model generating unit 120 aligns the behavior sequences by using a sequence alignment method to generate the reference model (S540). In this case, the reference model generating unit 120 connects behavior sequences having high similarity in a tree form by using the similarity of the extracted behavior sequences to generate an ontology type reference model.

FIG. 6 is a flowchart illustrating a process of generating a personalized lifestyle model in the personalized modeling device according to the exemplary embodiment of the present invention.

Referring to FIG. 6, the personalized modeling device 130 collects the lifelog including at least one of private data, public data, personal data, anonymous data, connected data, and sensor data (S610).

In addition, the personalized modeling device 130 extracts the individual behavior sequence in the collected lifelog (S620). In this case, the personalized modeling device 130 may extract the behavior pattern which is repeated more than a predetermined number of times as the individual behavior sequence for each individual in the collected lifelog by using the data mining method.

In addition, the personalized modeling device 130 extracts the individual tendency by using the collected lifelog (S630). In this case, the personalized modeling device 130 may analyze the individual tendency by analyzing activity information in the individual social network included in the collected lifelog.

In addition, the personalized modeling device 130 generates the personalized lifestyle model for each tendency by connecting the behavior sequences of the users having similar tendencies (S640). In this case, the personalized modeling device 130 analyzes similarity between the behavior sequences of the users having similar tendencies and may generate an ontology type personalized lifestyle model for each tendency by connecting the behavior sequences with high similarity in a tree form.

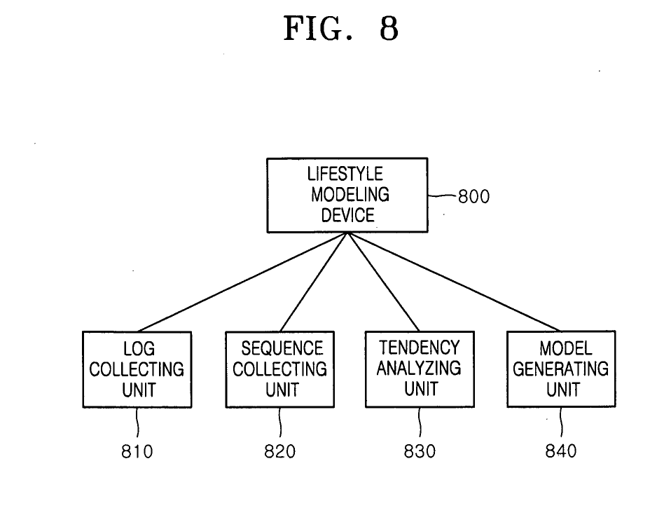

FIG. 8 is a diagram illustrating a configuration of an apparatus for modeling a personalized lifestyle according to another exemplary embodiment of the present invention.

Before the description, an apparatus 800 for modeling a personalized lifestyle of FIG. 8 may be a system included in the autonomous lifestyle care system 100 according to the exemplary embodiment of the present invention illustrated in FIG. 1.

Further, according to the exemplary embodiment of the present invention described above, the process of generating the reference model and the process of generating the personalized lifestyle models are generated independently or in parallel by using the respectively collected lifelogs. However, in the apparatus 800 for modeling the personalized lifestyle illustrated in FIG. 8, the personalized lifestyle model may be generated by referring to the reference model.

Referring to FIG. 8, the apparatus 800 for modeling the personalized lifestyle according to the exemplary embodiment of the present invention includes a log collecting unit 810, a sequence extracting unit 820, a tendency analyzing unit 830, and a personalized model generating unit 840.

The log collecting unit 810 collects lifelogs of multiple users and the lifelog collecting device 110 collects the lifelogs by communicating with a private data management server 151, a public data management server 152, a personal computer 153, a smart phone 154, smart glasses 155, a smart watch 157, a bicycle 158, a running machine 159, a vehicle 160, and the like.

In this case, the lifelog may include at least one of private data, public data, personal data, anonymous data, connected data, and sensor data, and the more detailed description thereof is described above and thus will be omitted below.

The sequence extracting unit extracts a sequence of the behaviors which frequently occur by using the collected lifelog for the personal user.

The tendency analyzing unit 830 calculates probability that the extracted sequence is associated with at least one of the reference models classified by a type with respect to the multiple users and extracts at least one optimal reference model matched with the extracted sequence.

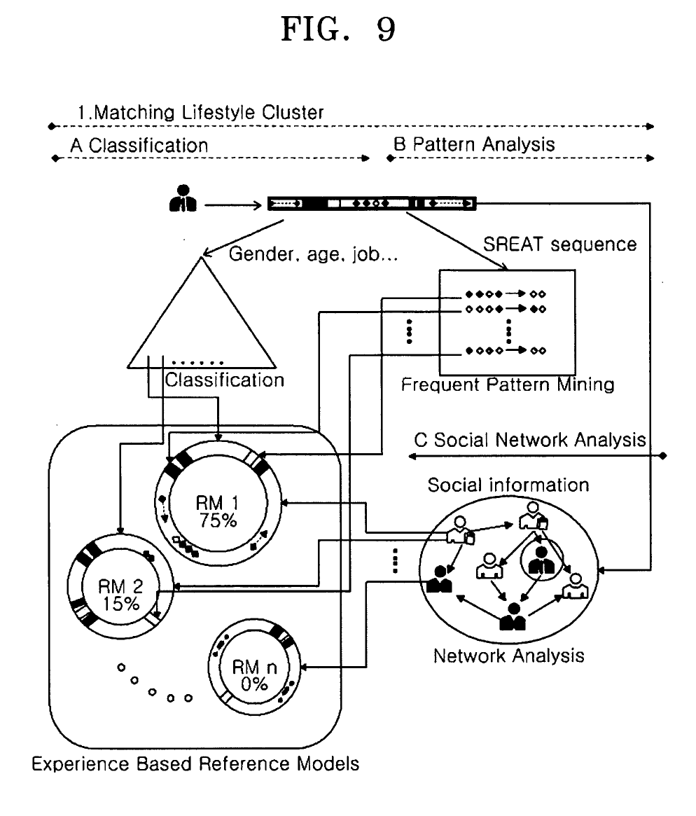

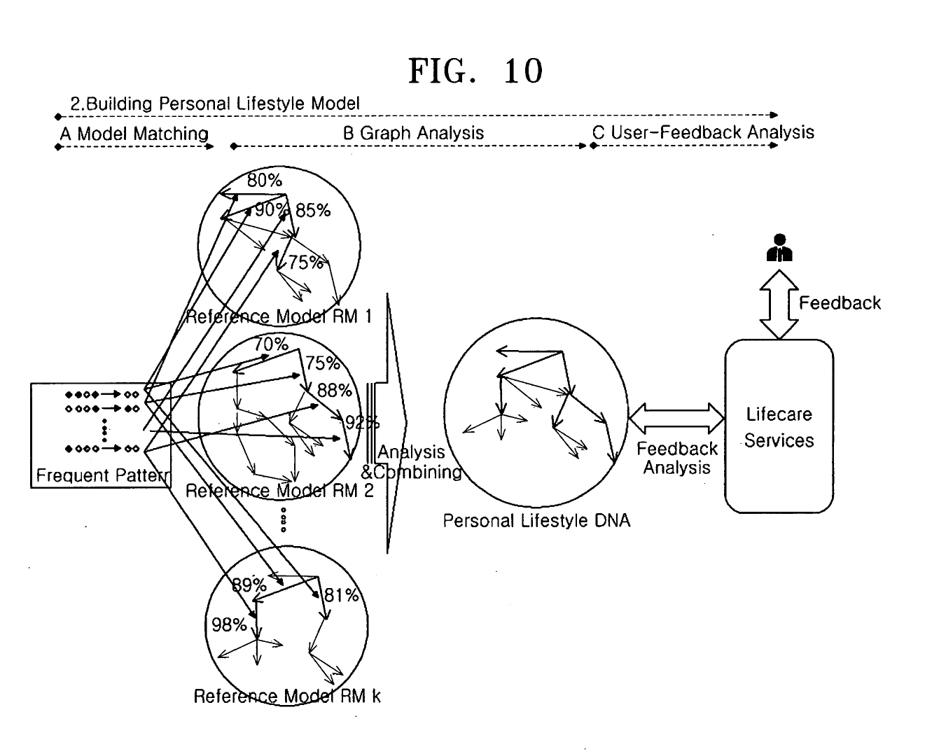

In this case, the tendency analyzing unit 830 expresses the behavior pattern in a graph form by matching the reference model with the extracted sequence. The graph may be expressed by granting a behavior weight correcting the pattern in addition to at least one of the reference model, a frequency of an actual behavior of a personal user, or a probability to be executed. The matching with the reference model and the behavior pattern expressed in the graph form will be described in detail with reference to FIGS. 9 and 10.

FIG. 9 is a diagram illustrating an example of matching the reference models according to the exemplary embodiment of the present invention.

Referring to FIG. 9, the sequence extracting unit 820 extracts the behavior pattern which is repeated more than a predetermined number of times for each individual in the lifelog of the personal user extracted in the log collecting unit 810. In addition, the tendency analyzing unit 830 matches with the extracted sequence by using at least one of reference models RM1, . . . , RMn which are classified by a type in the information included in the behavior sequence. That is, the information analyzing interest, taste, diet, and activity of each individual may be used for matching by analyzing activity information in the individual social network included in the collected lifelog. In this case, the activity information in the social network may include the number of access times to the social network, visited objects, the number of registered friends, the number of times of postings, the number of times of responses, analysis of the posting contexts, and the like. Through the analyzing process, the reference models having similar tendencies to the user are filtered in advance to be a help in extracting the optimal reference model based on the user's experience.

As illustrated in FIG. 9, as the result of classifying the user's behavior, a matching probability of RM1 is 75% and a matching probability of RM2 is 15%. In this case, it may be determined that a reference model which most efficiently describes the user's behavior is RM1.

The reference model matched with the user in this process may be used for generating the personalized lifestyle model. This will be described with reference to FIG. 10.

FIG. 10 is a diagram illustrating an example of generating a graph matching the reference models according to the exemplary embodiment of the present invention.

Referring to FIG. 10, k reference model candidates with a relatively high matching probability among n reference models of FIG. 9 are selected to become a target of graph analysis. The filtering of the reference model candidates may be performed by analyzing social big data of the user as described above.

Meanwhile, one or more most similar reference models to the user's behavior pattern may be selected through the graph analysis. However, the reference models determined to be most similar to the user's behavior pattern are just the reference models to have a difference from the user's actual behavior. For resolving the problem, the personalized model generating unit 840 generates a personalized lifestyle model adding the extracted actual behavior sequence to the optimal reference model by considering the difference between the reference model and the extracted actual behavior sequence. In the graph of FIG. 10, the reference model represents at least one extracted optimal reference model described in FIG. 9. A bold arrow of the optimal reference model represents a behavior pattern which is mostly conducted by the user and includes information on probability that the behavior pattern occurs. The personalized model generating unit 840 includes a lifestyle unique pattern extracting unit for generating the personalized lifestyle model by adding the optimal reference model and the behavior sequence of only the user. The lifestyle unique pattern extracting unit generates a personal habit unique pattern for only the personal user by adding the difference between the reference model and the extracted behavior sequence. In order to generate the personal habit unique pattern, a behavior weight which correct the difference between the behavior indicated in the reference model and the actual behavior of the personal user needs to be granted. To this end, in order to reconfigure one or more reference models to the personal model of only the user, the personal habit unique pattern of only the user is generated by adding a specific behavior pattern which is conducted by the user with more than a predetermined probability among the behavior patterns of the reference models.

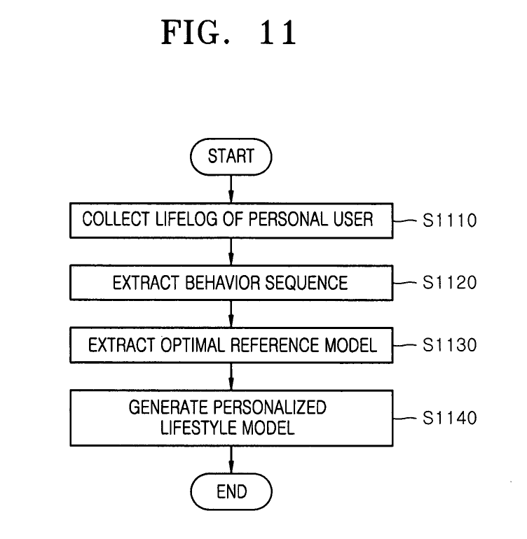

The personalized model generating unit 840 may perform correction of the weight through the feedback when there is a change in the user's behavior. That is, the personalized lifestyle model feed-backs the personalized data over time to additionally store the personalized model and thus, may continuously extend by generalizing the personalized data. The user's feedback may be an explicit active feedback directly expressing satisfaction of the user or may be an implicit passive feedback for whether to execute the behavior pattern of the reference model well by satisfying the provided reference model. The personalized lifestyle model united by reflecting the feedback information to the unique pattern may be generated. FIG. 11 is a flowchart illustrating a method for modeling a personalized lifestyle according to yet another exemplary embodiment of the present invention.

The method will be briefly described based on the description of FIG. 8.

Referring to FIG. 11, step S1110 is collecting lifelogs of multiple users, and the log collecting unit 810 collects lifelogs of multiple users. The lifelog collecting device 110 collects the lifelogs of multiple users and collects the lifelogs by communicating with a private data management server 151, a public data management server 152, a personal computer 153, a smart phone 154, smart glasses 155, a smart watch 157, a bicycle 158, a running machine 159, a vehicle 160, and the like.

In this case, the lifelog may include at least one of private data, public data, personal data, anonymous data, connected data, and sensor data, and the more detailed description thereof is described above and thus will be omitted below.

Step S1120 is extracting the behavior sequence, and a sequence of the behaviors which frequently occur by using the collected lifelog for the personal user is extracted.

Step S1130 is extracting an optimal reference model, and a graph type behavior pattern is expressed by matching at least one reference model with the extracted sequence. The graph may be expressed by granting a behavior weight to correct the difference between the behavior indicated by at least one reference model and the actual behavior of the personal user in addition to at least one of reference models and at least one of a frequency of the actual behavior of the personal user and a probability to be executed. In addition, the individual tendency is analyzed by using the activity information in the individual social network included in the collected lifelog to extract an optimal reference model by filtering the similar reference model to the user in advance. The activity information in the social network is the same as the content of FIG. 9 described above and will refer the content of FIG. 9 described above.

Step S1140 is generating a personalized lifestyle model, and further includes extracting a lifestyle unique pattern for generating the personalized lifestyle model by adding the difference between the reference model and the extracted sequence. In the generating of the personalized model, the personalized lifestyle model united by collecting user's feedback information to reflect the feedback information to the behavior weight of the lifestyle unique pattern is generated. This process is the same as the description of FIG. 10 described above and will be described with reference to the description of FIG. 10.

The personalized lifestyle model means a lifestyle model for a specific individual which is different from the reference model. For example, when a response to a specific stimulation and a specific motivated factor is beyond a predetermined range or more from any one of a plurality of reference models or difficult to be described even by any one of the plurality of reference models, the personalized lifestyle model may be formed. As the personalized lifestyle model is accumulated, models with high similarity among the separately generated personalized lifestyle models may be drawn. A new reference model may also be drawn by considering an appearance frequency, reproduction probability of a causal relationship, and the like of the plurality of drawn personalized lifestyle models.

The method for modeling the personalized lifestyle according to the exemplary embodiment of the present invention may be implemented as a program command which may be executed by various computers to be recorded in a computer readable medium.

The program command recorded in the medium may be specially designed and configured for the present invention, or may be publicly known to and used by those skilled in the computer software field. An example of the computer readable recording medium includes a magnetic media, such as a hard disk, a floppy disk, and a magnetic tape, an optical media, such as a CD-ROM and a DVD, a magneto-optical media, such as a optical disk, and a hardware device, such as a ROM, a RAM, a flash memory, an eMMC, specially formed to store and execute a program command. An example of the program command includes a high-level language code executable by a computer by using an interpreter, and the like, as well as a machine language code created by a compiler. The hardware device may be configured to be operated with one or more software modules in order to perform the operation of the present invention, and an opposite situation thereof is available.

The present invention has been described by the specified matters such as specific components and limited exemplary embodiments and drawings, which are provided to help the overall understanding of the present invention and the present invention is not limited to the exemplary embodiments, and those skilled in the art will appreciate that various modifications and changes can be made within the scope without departing from an essential characteristic of the present invention.

Therefore, the spirit of the present invention is defined by the appended claims rather than by the description preceding them, and the claims to be described below and it should be appreciated that all technical spirit which are evenly or equivalently modified are included in the claims of the present invention.

### INDUSTRIAL APPLICABILITY

The present invention relates to an apparatus and a method of modeling a personalized lifestyle which include collecting a lifelog, extracting an individual behavior sequence in the collected lifelog, analyzing an individual tendency by using the collected lifelog, and generating a personalized lifestyle model by retrieving reference models with similar tendencies and considering the reference model and the personal tendency.

1. An apparatus for modeling a personalized lifestyle comprising: a log collecting unit configured to collect a lifelog of a personal user;
a sequence extracting unit configured to extract a sequence of a behavior which frequently occurs by using the collected lifelog with respect to the personal user;
a tendency analyzing unit configured to calculate a probability that the extracted sequence is associated with at least one of reference models classified for each type with respect to multiple users and extract at least one optimal reference model matched with the extracted sequence; and
a personalized model generating unit configured to generate a personalized lifestyle model which adds the extracted sequence to the optimal reference model by considering the difference between the reference model and the extracted sequence.

2. The apparatus for modeling the personalized lifestyle of claim 1, wherein the lifelog includes at least one of private data, public data, personal data, anonymous data, connected data, and sensor data.

3. The apparatus for modeling the personalized lifestyle of claim 1, wherein the tendency analyzing unit expresses a behavior pattern in a graph form by matching at least one of the reference models with the extracted sequence.

4. The apparatus for modeling the personalized lifestyle of claim 3, wherein in the graph, a behavior weight is granted to correct a difference between a behavior indicated by at least one of the reference models and an actual behavior of the personal user in addition to at least one of the reference models and at least one of a frequency of the actual behavior of the personal user and a probability to be executed.

5. The apparatus for modeling the personalized lifestyle of claim 1, wherein the tendency analyzing unit analyzes the individual tendency by using activity information in an individual social network included in the collected lifelog and extracts an optimal reference model by filtering the reference model similar to the user in advance.

6. The apparatus for modeling the personalized lifestyle of claim 1, wherein the personalized model generating unit further includes a lifestyle unique pattern extracting unit for generating a personalized lifestyle model by adding the difference between the reference model and the extracted sequence.

7. The apparatus for modeling the personalized lifestyle of claim 1, wherein the personalized model generating unit generates a personalized lifestyle model united by collecting feedback information of the user to reflect the collected feedback information to the behavior weight of the lifestyle unique pattern.

8. A method for modeling a personalized lifestyle comprising: collecting a lifelog of a personal user;
extracting a sequence of a behavior which frequently occurs by using the collected lifelog with respect to the personal user;
calculating a probability that the extracted sequence is associated with at least one of reference models classified for each type with respect to multiple users and extracting at least one optimal reference model matched with the extracted sequence; and
generating a personalized lifestyle model which adds the extracted sequence to the optimal reference model by considering the difference between the reference model and the extracted sequence.

9. The method for modeling the personalized lifestyle of claim 8, wherein the lifelog includes at least one of private data, public data, personal data, anonymous data, connected data, and sensor data.

10. The method for modeling the personalized lifestyle of claim 8, wherein in the analyzing of the tendency, a behavior pattern is expressed in a graph form by matching at least one of the reference models with the extracted sequence.

11. The method for modeling the personalized lifestyle of claim 10, wherein in the graph, a behavior weight is granted to correct a difference between a behavior indicated by at least one of the reference models and an actual behavior of the personal user in addition to at least one of the reference models and at least one of a frequency of the actual behavior of the personal user and a probability to be executed.

12. The method for modeling the personalized lifestyle of claim 7, wherein in the analyzing of the tendency, the individual tendency is analyzed by using activity information in an individual social network included in the collected lifelog and an optimal reference model is extracted by filtering the reference model similar to the user in advance.

13. The method for modeling the personalized lifestyle of claim 7, wherein the generating of the personalized model further includes a lifestyle unique pattern extracting unit for generating a personalized lifestyle model by adding the difference between the reference model and the extracted sequence.

14. The method for modeling the personalized lifestyle of claim 7, wherein in the generating of the personalized model, a personalized lifestyle model united by collecting feedback information of the user to reflect the collected feedback information to the behavior weight of the lifestyle unique pattern is generated.

15. (canceled)
